(19) United States
(12) Patent Application Publication
(10) Pub. No.: US 2024/0142073 A1
(43) Pub. Date: May 2, 2024

(54) METHOD OF FORMING A PHOTOVOLTAIC LIGHT FIXTURE

(71) Applicant: Dennis M. Danzik, Cody, WY (US)

(72) Inventor: Dennis M. Danzik, Cody, WY (US)

(21) Appl. No.: 18/500,745

(22) Filed: Nov. 2, 2023

Related U.S. Application Data
(60) Provisional application No. 63/382,076, filed on Nov. 2, 2022.

(51) Int. Cl. F21S 9/03; F21V 23/06; H02S 40/36; H02S 40/38

(52) U.S. Cl. CPC F21S 9/03; F21V 23/06; H02S 40/36; H02S 40/38

(57) ABSTRACT

Implementations of a method of forming a photovoltaic light fixture may include coupling a photovoltaic construction to an interior surface of a light fixture housing. The photovoltaic construction may include a photovoltaic module having a plurality of photovoltaic cells and outgoing photovoltaic wiring directly coupled electrically and mechanically to the photovoltaic module. The method may also include electrically coupling the outgoing photovoltaic wiring to either a battery or a capacitor. The outgoing photovoltaic wiring may include either a universal serial bus (USB) cable or a power over ethernet (PoE) cable. The USB cable or the PoE cable may be configured to harvest power from the photovoltaic module.

### CROSS REFERENCE TO RELATED APPLICATIONS

This document claims the benefit of the filing date of U.S. Provisional Patent Application 63/382,076, entitled “Method of Forming a Photovoltaic Light Fixture” to Dennis Danzik which was filed on Nov. 2, 2023, the disclosure of which is hereby incorporated entirely herein by reference.

### BACKGROUND

### 1. Technical Field

Aspects of this document relate generally to alternative energy. More specific implementations involve photovoltaic modules.

### 2. Background

Alternative energy sources are becoming increasingly important in view of the depletion of fossil fuel sources. Alternative energy sources may include light, wind, or hydropower sources. Photovoltaic modules capture light and convert it into electrical current.

### SUMMARY

Implementations of a method of forming a photovoltaic light fixture may include coupling a photovoltaic construction to an interior surface of a light fixture housing. The photovoltaic construction may include a photovoltaic module having a plurality of photovoltaic cells and outgoing photovoltaic wiring directly coupled electrically and mechanically to the photovoltaic module. The method may also include electrically coupling the outgoing photovoltaic wiring to either a battery or a capacitor. The outgoing photovoltaic wiring may include either a universal serial bus (USB) cable or a power over ethernet (PoE) cable. The USB cable or the PoE cable may be configured to harvest power from the photovoltaic module.

Implementations of methods of forming a photovoltaic light fixture may include one, all, or any of the following:

The outgoing photovoltaic wiring may include the USB cable.

The USB cable may harvest the power through only two of four conductors within the USB cable.

The USB cable may be configured to harvest between 1-71 watts through each conductor that harvests the power.

The outgoing photovoltaic wiring may include the PoE cable.

The PoE cable may harvest the power through only four of eight conductors within the PoE cable.

The PoE cable may be configured to harvest between 1-71 watts through each conductor that harvests the power.

The photovoltaic module may be configured generate electricity when exposed to light having a wavelength between 380-750 nanometers.

Implementations of the method may include forming one or more openings through the housing through which the outgoing photovoltaic wiring is configured to extend.

Implementations of a method of forming a photovoltaic light fixture may include coupling a photovoltaic construction to an interior surface of a light fixture housing through a plurality of magnets. The photovoltaic construction may include a photovoltaic module having a plurality of photovoltaic cells. The photovoltaic module may be fixedly coupled to a backplate. The photovoltaic construction may also include outgoing photovoltaic wiring directly coupled electrically and mechanically to the photovoltaic module. The method of forming a photovoltaic light fixture may include electrically coupling the outgoing photovoltaic wiring to one of a battery or a capacitor. The outgoing photovoltaic wiring may include either a universal serial bus (USB) cable or a power over ethernet (PoE) cable. The USB cable or the PoE cable may be configured to harvest power from the photovoltaic module. The plurality of magnets may be directly coupled to the backplate. The photovoltaic module may be configured to be between the housing and a lightbulb housed by the housing. The photovoltaic module may be configured to generate electricity using visible light emitted from the lightbulb.

Implementations of methods of forming a photovoltaic light fixture may include one, all, or any of the following:

The outgoing photovoltaic wiring may include the USB cable. The USB cable may be configured to harvest the power through only two of four conductors within the USB cable.

The outgoing photovoltaic wiring may include the PoE cable. The PoE cable may harvest the power through only four of eight conductors within the PoE cable.

The USB cable or PoE cable may be configured to harvest between 1-71 watts through each conductor that harvests the power in the one of the USB cable or the PoE cable.

The photovoltaic module may be configured to generate electricity when exposed to light having a wavelength between 380-750 nanometers.

Implementations of the method of forming a photovoltaic light fixture may include forming one or more openings through the housing through which the outgoing photovoltaic wiring may be configured to extend.

Implementations of a method of retrofitting a light fixture may include removing a light fixture from a structure, removing one or more bulbs from the light fixture, and coupling a photovoltaic construction to an interior surface of a light fixture housing. The photovoltaic construction may include a photovoltaic module having a plurality of photovoltaic cells and outgoing photovoltaic wiring directly coupled electrically and mechanically to the photovoltaic module. The method of retrofitting a light fixture may include electrically coupling the outgoing photovoltaic wiring to either a battery or a capacitor, reinstalling the one or more bulbs into the light fixture, and reinstalling the light fixture to the structure. The outgoing photovoltaic wiring may include either a universal serial bus (USB) cable or a power over ethernet (PoE) cable. The USB cable or the PoE cable may be configured to harvest power from the photovoltaic module. The photovoltaic module may be configured to generate electricity using visible light emitted from the one or more bulbs.

Implementations of methods of retrofitting a light fixture may include one, all, or any of the following:

The one or more lightbulbs may be low voltage lightbulbs.

Implementations of retrofitting a light fixture may include forming one or more openings through the housing through which the outgoing photovoltaic wiring is configured to extend.

The outgoing photovoltaic wiring may include the USB cable. The USB cable may be configured to harvest the power through only two of four conductors within the USB cable

The outgoing photovoltaic wiring may include the PoE cable. The PoE cable may be configured to harvest the power through only four of eight conductors within the PoE cable.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 is a break apart view of a photovoltaic construction;

FIG. 2 is a view of the cover side of the photovoltaic construction;

FIG. 3 is a side view of the photovoltaic construction;

FIG. 4 is a view of the backplate side of the photovoltaic construction;

FIG. 5 is a view of a universal serial bus (USB) connector;

FIG. 6 is a schematic of the USB connector of FIG. 5;

FIG. 7 is a view of a power-over-ethernet (PoE) connector;

FIG. 8 is a schematic of the PoE connector of FIG. 7;

FIG. 9 is a bottom perspective view of a photovoltaic light fixture;

FIG. 10 is a top perspective and partially exploded view of the light fixture of FIG. 9; and

FIG. 11 is a bottom perspective and partially exploded view of FIG. 10.

### DESCRIPTION

This disclosure, its aspects and implementations, are not limited to the specific components, assembly procedures or method elements disclosed herein. Many additional components, assembly procedures and/or method elements known in the art consistent with the intended methods of forming a photovoltaic light fixture will become apparent for use with particular implementations from this disclosure. Accordingly, for example, although particular implementations are disclosed, such implementations and implementing components may comprise any shape, size, style, type, model, version, measurement, concentration, material, quantity, method element, step, and/or the like as is known in the art for such methods of forming a photovoltaic light fixture, and implementing components and methods, consistent with the intended operation and methods.

The photovoltaic light fixtures and elements thereof described in U.S. patent application Ser. No. 18/500,591, entitled “Photovoltaic Construction” to Dennis Danzik, filed on Nov. 2, 2023, the disclosure of which is hereby incorporated entirely herein by reference, may be included in any light fixtures and elements thereof disclosed herein and may be formed by the methods disclosed herein.

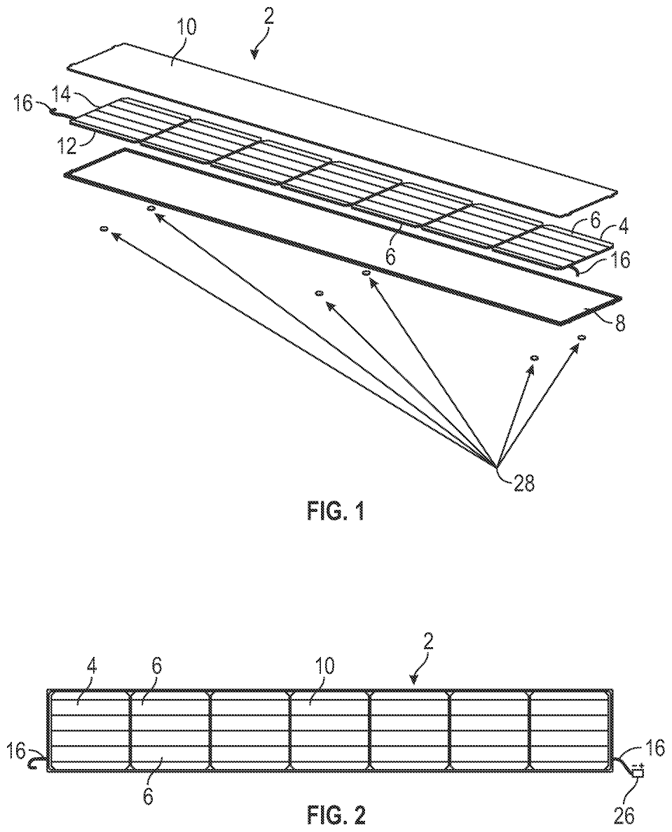

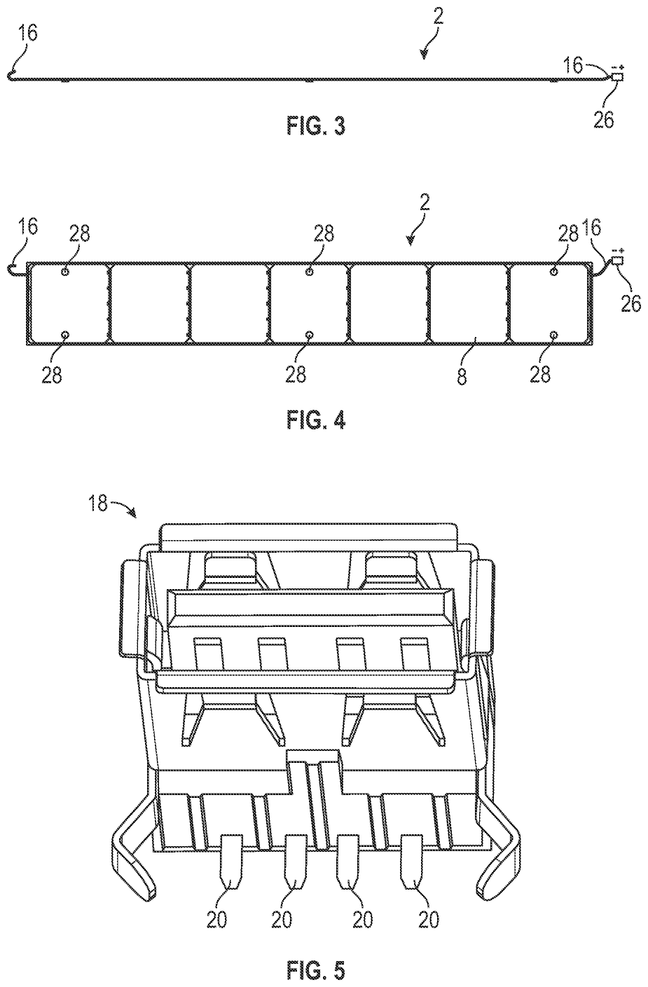

The method of forming a photovoltaic light fixture includes coupling a photovoltaic construction to an interior surface of a light fixture housing. Referring to FIG. 1, a break apart view of a photovoltaic construction is illustrated. Referring to FIG. 2, a cover side of the photovoltaic construction is illustrated. Referring to FIG. 3, a side view of the photovoltaic construction is illustrated. Referring to FIG. 4, a back plate side of the photovoltaic construction is illustrated. The photovoltaic construction 2 includes a photovoltaic module 4 having a first side 12 and a second side 14. The photovoltaic module 4 includes a plurality of photovoltaic cells 6. As used herein, a plurality of photovoltaic cells make up a photovoltaic module and one or more photovoltaic modules make up a photovoltaic array. The photovoltaic module is configured to generate electricity or power in response to light hitting the photovoltaic module. The photovoltaic cells that generate the electricity or power may be made from, by nonlimiting example, polycrystalline silicon, amorphous silicon, dye-sensitized (flexible) silicon, other types of silicon, or other materials capable of producing electricity through the photovoltaic effect. In particular implementations, each photovoltaic cell is configured to generate electricity when exposed to light having a wavelength between 380 and 750 nm. In other implementations, the photovoltaic cells 6 may be configured to generate electricity when exposed to light having wavelength of less than 380 nm or more than 750 nm. The photovoltaic cells 6 may be optimized to generate more electricity from exposure to visible light than the standard photovoltaic cell included in a rooftop solar panel.

In various implementations the photovoltaic construction may include a single photovoltaic module. In other implementations the photovoltaic construction may include more than one photovoltaic module, including two, three, four, five, six, seven, eight or more than eight photovoltaic modules. In implementations having more than one photovoltaic module, the photovoltaic modules may lie in the same plane or may be angled relative to one another. Any of the photovoltaic modules of the photovoltaic construction may be planar. In other implementations, any of the photovoltaic modules of the photovoltaic construction may be curved.

In various implementations, the photovoltaic construction 2 may include a back plate 8 fixedly coupled to and over the first side 12 of the photovoltaic module. In other implementations, the photovoltaic module may not be coupled to a back plate but may be configured to mount directly to a surface configured to hold the photovoltaic construction. The back plate 8 may be made from, by nonlimiting example, metal, a polymer based material, or any other material having a rigidity sufficient to support the plurality of photovoltaic cells 6.

In various implementations, the photovoltaic construction includes a cover 10 coupled to and over the second side 14 of the photovoltaic module. The cover 10 is optically transmissive.

In implementations of photovoltaic constructions including multiple photovoltaic modules, the photovoltaic construction may include module wiring configured to couple the photovoltaic modules together. The multiple photovoltaic modules may be wired together in series or parallel. In particular implementations, the module wiring may include any type of USB cable or PoE cable disclosed herein.

The photovoltaic construction includes outgoing photovoltaic wiring 16 directly coupled electrically and mechanically to the photovoltaic module 4. The outgoing photovoltaic wiring is configured to harvest the power from the photovoltaic module (or modules) and couples the photovoltaic module to a power receiving source, such as a capacitor or a battery. The outgoing photovoltaic modules may harvest the power in the form of direct current. FIGS. 1-4 illustrate two separate wires as part of the outgoing photovoltaic wiring 16. These two wires represent a wire configured to carry a positive charge and a wire configured to carry a negative charge. While these are illustrated on opposing ends of the photovoltaic module, the positive and/or negative charge may be routed so the channel configured to carry the positive charge and the channel configured to carry the negative charge extend from the photovoltaic module in the same cable.

In various implementations, the outgoing photovoltaic wiring includes a universal serial bus (USB) cable. The USB cable may be, by non-limiting example, a USB type A cable, a USB type B cable, a USB 3.0 cable, a USB mini cable, a USB micro cable, a USB type C cable, a USB micro B cable, or any other USB cable. In such implementations the USB cable harvests the power generated from the photovoltaic module. The USB cable can harvest the power because the USB cable may be directly wired (or soldered) to the output of the photovoltaic module. In such implementations, the current from the photovoltaic module may be fed directly into the USB cable without first reaching any kind of controller, battery, capacitor, or switch. In similar implementations, a USB female connector may be directly wired (or soldered) to the output of the photovoltaic module. In such implementations, a USB cable may be plugged directly into the connector and the current from the photovoltaic module may be fed directly into the USB cable, through the connector, without first reaching any kind of controller, battery, capacitor, or switch. In either implementation, because the current from the photovoltaic module is transmitted directly into the USB cable or directly into the USB cable through the connector, the USB cable is considered to “harvest” the power generated.

In implementations including multiple photovoltaic modules, one or more USB female connectors may be directly wired (or soldered) to the output of each photovoltaic module. These connectors may allow for a plurality of USB cables to be used to wire the photovoltaic modules together. The photovoltaic modules may be wired in series or parallel. In other implementations, multiple photovoltaic modules may be wired together without the use of the USB female connectors.

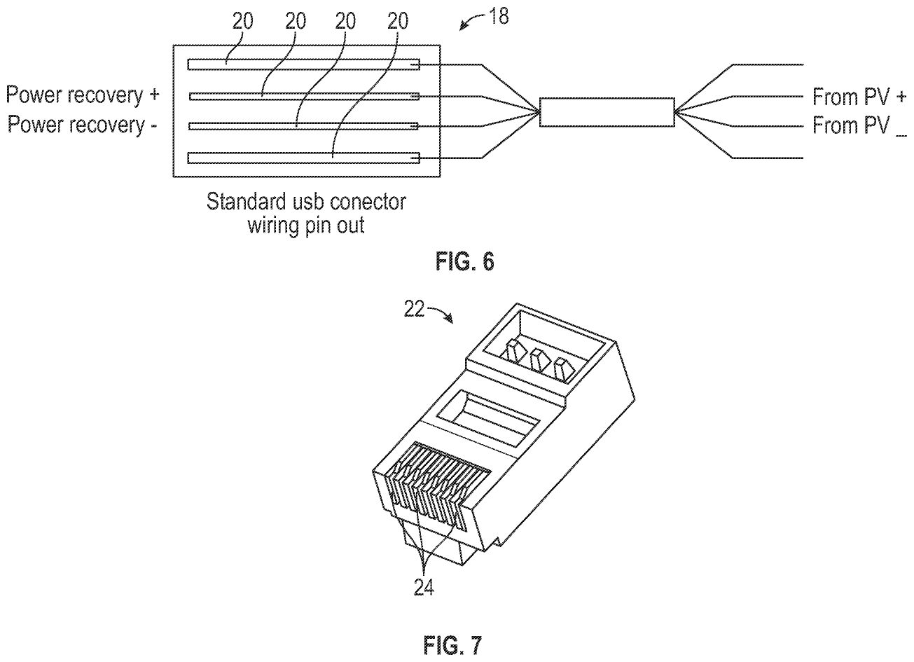

Referring to FIG. 5, a view of a USB connector is illustrated. Referring to FIG. 6, a schematic of the USB connector of FIG. 5 is illustrated. The USB connector 18 includes four terminals 20. These four terminals correspond to four conductors, or channels, that extend through the USB cable. In various implementations, the USB cable is configured to harvest power from the photovoltaic module through only two of the four conductors within the USB cable. In other implementations, the USB cable may be configured to harvest power through all four conductors. Each conductor that harvests power may harvest between 1-71 watts. In other implementations, each conductor within the USB cable that harvests power may be configured to harvest less than 1 watt or more than 71 watts.

In other implementations, the outgoing photovoltaic wiring includes a power-over-ethernet (PoE) cable. The PoE cable may be, by non-limiting example, a Cat-3 cable, a Cat-5 cable, a Cat-5e cable, a Cat-6 cable, a Cat-6a cable, a Cat-7 cable, a Cat-8 cable, or any other type of PoE cable. In such implementations the PoE cable harvests the power generated from the photovoltaic module. The PoE cable harvests the power because the PoE cable may be directly wired (or soldered) to the output of the photovoltaic module. In such implementations, the current from the photovoltaic module may be fed directly into the PoE cable without first reaching any kind of controller, injector, battery, capacitor, or switch. In similar implementations, a PoE female connector may be directly wired (or soldered) to the output of the photovoltaic module. In such implementations, a PoE cable may be plugged directly into the connector and the current from the photovoltaic module may be fed directly into the PoE cable, through the connector, without first reaching any kind of controller, injector, battery, capacitor, or switch. In either implementation, because the current from the photovoltaic module is transmitted directly into the PoE cable or directly into the PoE cable through the connector, the PoE cable is considered to “harvest” the power generated.

In implementations including multiple photovoltaic modules, one or more PoE female connectors may be directly wired (or soldered) to the output of each photovoltaic module. These connectors may allow for a plurality of PoE cables to be used to wire the photovoltaic modules together. The photovoltaic modules may be wired in series or parallel. In other implementations, multiple photovoltaic modules may be wired together without the use of the PoE female connectors.

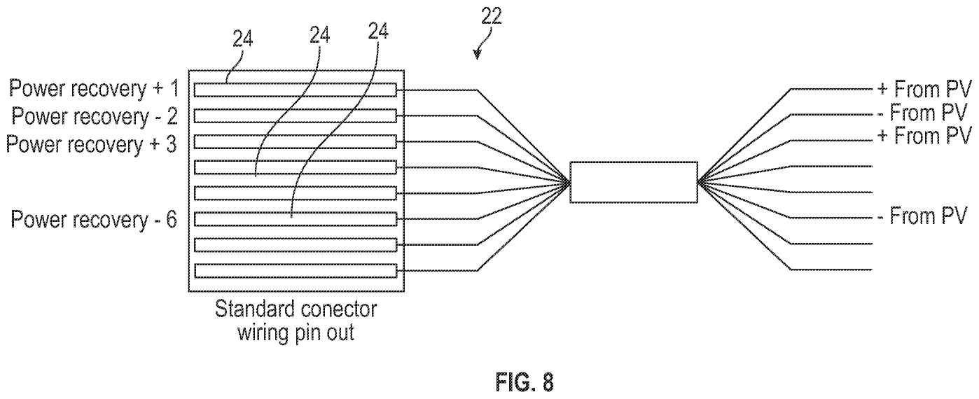

Referring to FIG. 7, a view of a PoE connector is illustrated. Referring to FIG. 8, a schematic of the PoE connector of FIG. 7 is illustrated. The PoE connector 22 includes eight terminals 24. These eight terminals correspond to eight conductors, or channels, that extend through the PoE cable. In various implementations, the PoE cable is configured to harvest power from the photovoltaic module through only four of the eight conductors within the PoE cable. In other implementations, the PoE cable may be configured to harvest power through all eight conductors, six conductors, or two conductors. Each conductor that harvests power may harvest between 1-71 watts (Cat-8 PoE cables may be configured to harvest up to 71 watts per conductor). In other implementations, each conductor within the PoE cable that harvests power may be configured to harvest less than 1 watt or more than 71 watts.

Either the USB cable or the PoE cable may be configured to feed the power harvested into either a capacitor or a battery. Either the USB cable or the PoE cable, depending on the particular implementation, forms the output of the outgoing photovoltaic wiring (i.e. additional elements that the USB cable or PoE cable may feed into are not considered part of the outgoing photovoltaic wiring). Referring to FIGS. 2-4, a battery 26 is illustrated with the outgoing photovoltaic wiring 16 coupled between the battery 26 and the photovoltaic module 4.

The photovoltaic construction 2 may include a plurality of attachment mechanisms 28, as illustrated by FIGS. 2-4. In implementations having a back plate 8, the attachment mechanisms 28 may be directly coupled to the back plate. In implementations not having a back plate, the attachment mechanisms 28 may be directly coupled to the photovoltaic module. In various implementations, the attachment mechanisms may be magnets. In other implementations, the attachments mechanisms may include, by non-limiting example, an adhesive, clip, or other attachment mechanism.

In various implementations, the method of forming the photovoltaic light fixture not only includes coupling the photovoltaic construction within a light fixture housing but also includes forming the photovoltaic construction 2. In such implementations, the method may include electrically and mechanically coupling outgoing photovoltaic wiring 16 to a photovoltaic module 4. This may be done by either soldering a USB cable or a PoE cable to an output of the photovoltaic module, or by soldering a USB female connector or a PoE female connector to an output of the photovoltaic module. In implementations of the method including soldering the female connector, the method may include coupling either a USB cable or a PoE cable into the USB connector or the PoE connector. In implementations including multiple photovoltaic modules, the method may also include wiring the photovoltaic modules together. The photovoltaic modules may be wired together in series or in parallel. In particular implementations, the photovoltaic modules may be wired together using any type of USB cable or PoE cable disclosed herein. The method of forming the photovoltaic construction 2 may also include coupling a cover 10 over the second side 14 of the photovoltaic module 4 and coupling a back plate 8 over the first side 12 of the photovoltaic module. In implementations including a back plate 8, the method may include attaching one or more attachment mechanisms to the back plate 8 through which the photovoltaic construction may be coupled to the light fixture housing. The attachment mechanisms may be directly coupled to the back plate or directly coupled to the back plate through an adhesive. In implementations not having a back plate, the method may include attaching the attachment mechanisms to the photovoltaic module.

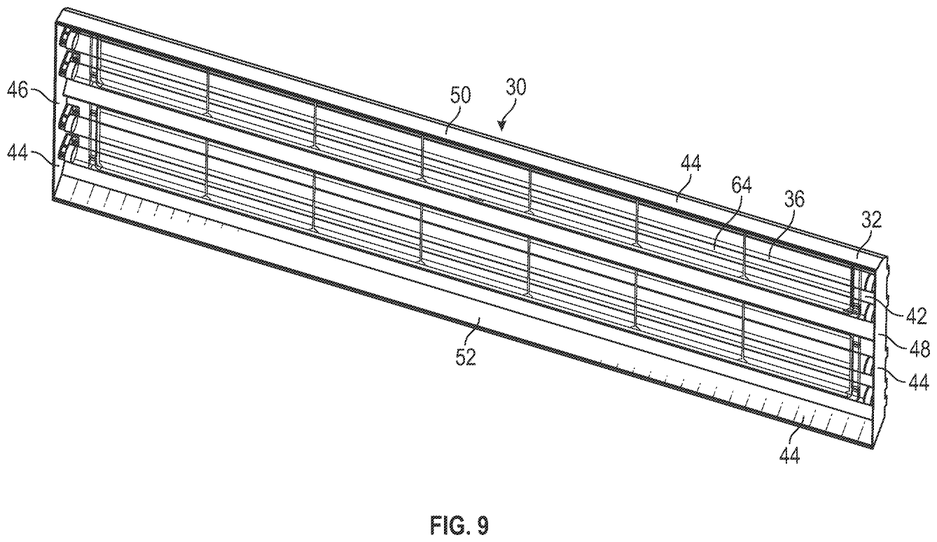

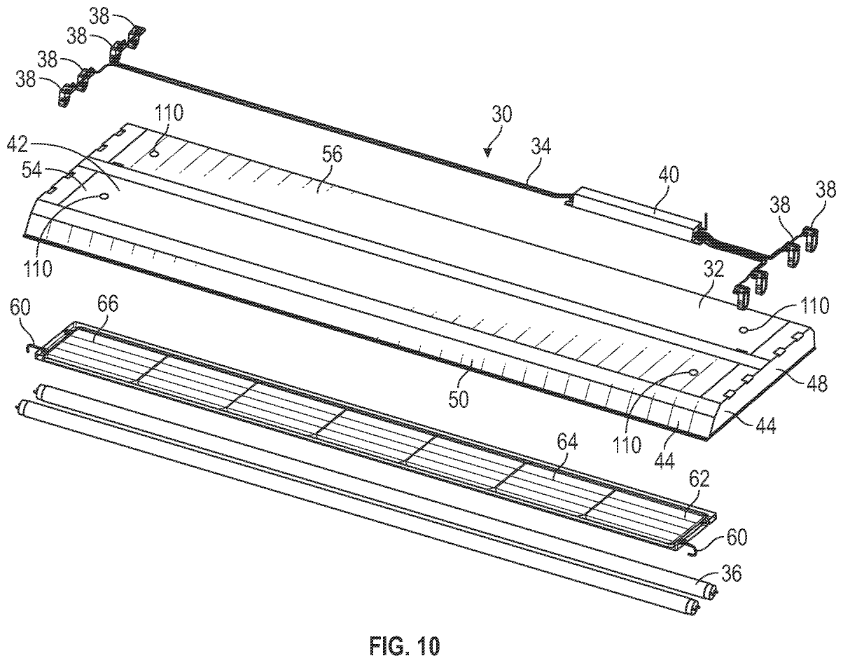

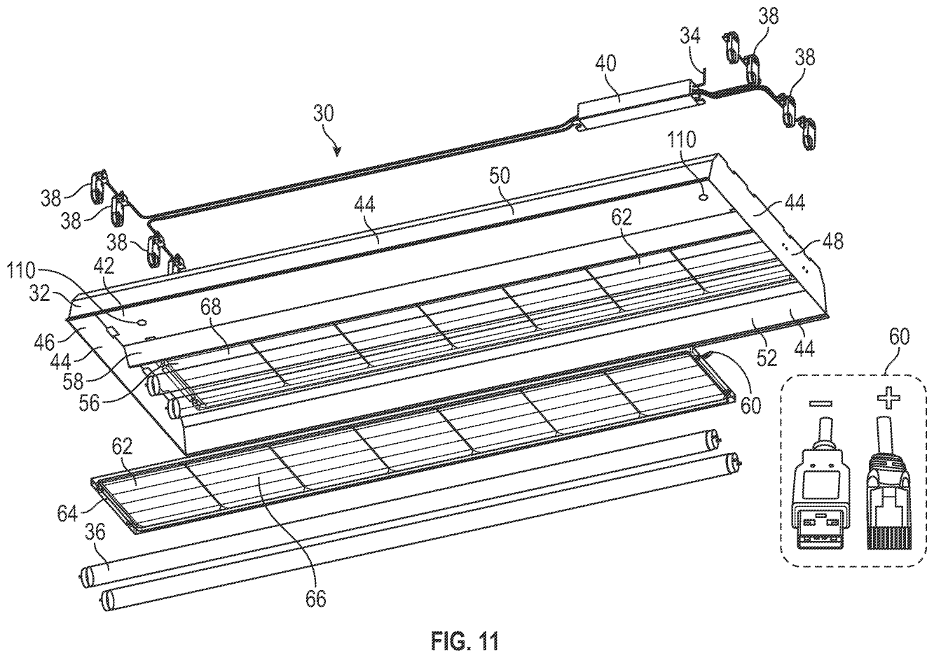

Referring to FIG. 9, a bottom view of a photovoltaic light fixture is illustrated. As used herein, “bottom” refers to the side of the photovoltaic light fixture having the opening through which light is emitted and “top” refers to the side opposite the bottom. Referring to FIG. 10, a top perspective and partially exploded view of the light fixture of FIG. 9 is illustrated. Referring to FIG. 11, a bottom perspective and partially exploded view of FIG. 10 is illustrated. Implementations of the methods of forming photovoltaic light fixtures disclosed herein may be configured to form the photovoltaic light fixture illustrated by FIGS. 9-11. While FIGS. 9-11 illustrate a particular photovoltaic light fixture, it is understood that the method of including photovoltaic cells within a light fixture to generate electricity from the light emitted from the lightbulb or light emitting device within the light fixture may be applied to any other type of light fixture configured to include any type of lightbulb or light emitting device, including any type of light fixture or lightbulb disclosed in U.S. patent application Ser. No. 18/500,591. In various implementations, the lightbulbs or light emitting devices configured to be housed within the light fixture housing may be considered low voltage. As used herein, low voltage is less than 60 volts.

As illustrated by FIGS. 9-11, the method of forming a photovoltaic light fixture 30 requires a light fixture housing 32 and electrical wiring 34 configured to provide power to a bulb 36 or light emitting device within the light fixture housing. In various implementations, the method may also require one or more bulb connectors 38 coupled to the electrical wiring 34. In various implementations the light fixture housing 32, bulb connectors 38, and electrical wiring 34 may be the same as or similar to the housings, bulb connectors, and electrical wiring disclosed in U.S. patent application Ser. No. 18/500,591. As illustrated by FIGS. 9-11, the method of forming a photovoltaic light fixture may also require a ballast 40, though in other implementations the method of forming the photovoltaic light fixture may not require or include a ballast.

In various implementations, the light fixture housing 32 may include, by nonlimiting example, a metallic material, a polymer based material, or any other type of material sufficiently rigid to form a light fixture housing. While FIGS. 9-11 illustrate the housing 32 as a sheet metal fixture, it is understood that the housing 32 may be made of other materials in other implementations. Referring to FIGS. 9-11, the light fixture housing 32 may include an interior configured to receive one or more lightbulbs 36. In particular implementations, the housing 32 is configured to receive linear lightbulbs. In such implementations, the housing may be configured to receive a single linear light bulb, two linear lightbulbs, three linear lightbulbs, four linear lightbulbs, or more than four linear lightbulbs. The linear lightbulbs may be 4 feet long. In other implementations, the linear lightbulbs may be more than or less than 4 feet in length.

In various implementations, and as illustrated by FIGS. 9-11, the housing includes a base 42. The base is opposite an opening of the light fixture through which light is configured to pass and illuminate the surrounding area. The base 42 may be substantially rectangular. In various implementations, the housing 32 includes a plurality of walls 44 directly coupled to the base 42. In particular implementations, and as illustrated by FIGS. 9-11, the housing may include a first wall 46, a second wall 48 opposite the first wall, a third wall 50, and a fourth wall 52 opposite the third wall. The third wall 50 and the fourth wall 52 may be coupled between the first wall 46 and the second wall 48. In various implementations, a portion of or all of the walls of the plurality of walls 44 may be substantially perpendicular to the surface of the base 42. In other implementations, a portion of the walls or all of the walls 44 may form a non-right angle with the base 42. In particular implementations, and as illustrated by FIGS. 9-11, the third wall 50 and the fourth wall 52 each include a portion that forms a non-right angle with the base 42. In various implementations, and as illustrated by FIGS. 9-11, the housing may substantially form the shape of a rectangular prism.

In various implementations, and as illustrated by FIGS. 9-11, the base 42 may include a first portion 54 and a second portion 56 divided by a divider 58. In other implementations the housing may not include a divider.

In other implementations, the housing of the light fixture may include a structure different from that illustrated by FIGS. 9-11, including any structure of any light fixture housing disclosed in U.S. patent application Ser. No. 18/500,591. In still other implementations, implementations of the housing may include structures the same as or similar to the housings of any other light fixture.

Implementations of the housings disclosed herein may be configured to house or couple to any type of lightbulb or device that emits light disclosed herein or in U.S. patent application Ser. No. 18/500,591. Further, implementations of the housings disclosed herein may be configured to house or couple to a single lightbulb, two lightbulbs, three lightbulbs, four lightbulbs, or more than four lightbulbs.

In various implementations, the method of forming a photovoltaic light fixture may include forming one or more openings 110 in the housing 32 configured to receive the outgoing photovoltaic wiring 60 that couples the one or more photovoltaic modules 62 to a capacitor or battery. In such implementations, the one or more openings may be positioned near the connection point of the outgoing photovoltaic wiring 60 to the photovoltaic module 62 when the photovoltaic module is coupled to the housing 32. This may allow for the bulk of the outgoing photovoltaic wiring to be hidden from view and on the outer surface of the base 42 of the housing 32.

In other implementations, the method may not include forming an opening through the housing 32 but may include extending the outgoing photovoltaic wiring through existing openings already present in the housing. In particular implantations, such openings may include bulb connector openings that are not completely occupied by the bulb connectors.

In still other implementations, the method may not include forming an opening through the housing 32 but may include running the outgoing photovoltaic wiring 60 from the interior of the housing, over an edge of a wall of the housing, and to an external area on the outside of the housing 32.

The method of forming a photovoltaic light fixture includes coupling the one or more photovoltaic modules 62 of the photovoltaic construction 64 within the housing 32 between the housing and the bulb or light source configured to be held by the light fixture. The one or more photovoltaic modules may be installed within the housing in a manner that does not block the opening of the housing through which light emitted by the one or more bulbs is configured to pass and illuminate the surrounding area. In various implementations, the method includes coupling the one or more photovoltaic modules 62 along a base or one or more walls of the interior of the housing. In particular implementations, and as illustrated by FIGS. 9-11, the method may include coupling a first photovoltaic module 66 over a first portion 54 of the base 42 of the light fixture 30 and coupling a second photovoltaic module 68 over a second portion 56 of the base. The first and second portions of the base may be separated by a divider 58. While the light fixture of FIGS. 9-11 include two photovoltaic modules configured to generate electricity from the light emitted from four bulbs, other implementations of methods of forming photovoltaic light fixtures may include coupling additional photovoltaic modules on the first wall, second wall, third wall, fourth wall, divider, or any combination thereof. Other implementations may include coupling only a single photovoltaic module to a housing.

In other implementations, the method may include coupling one or more photovoltaic modules to any other portion of an interior of a housing as described in U.S. patent application Ser. No. 18/500,591.

Referring to FIGS. 1 and 4, the photovoltaic construction may couple to the interior surface of the light fixture housing through a plurality attachment mechanisms 28. In various implementations, the attachment mechanisms may include magnets which may be permanent magnets. In particular implementations twelve magnets may be used to couple a single photovoltaic module to the housing. In other implementations, more than or less than twelve magnets may be used to couple the photovoltaic module to the housing. As an example, the photovoltaic module of FIGS. 1 and 4 configured to couple to a housing through six magnets. In various implementations the photovoltaic module is coupled to a metallic back plate. In such implementations the plurality of magnets may attach to the photovoltaic module through magnetic force. In other implementations, including implementations not having a back plate or not having a metallic back plate, the magnets may be directly attached to the photovoltaic module through an adhesive. In implementations where the housing is metallic, the magnets may be coupled to the housing through magnetic force. In other implementations, including implementations in which the housing is not metallic, the magnets may be attached to the housing through an adhesive and may then couple to the metallic back plate through magnetic force. In implementations including magnets, the number and strength of magnets used to couple the photovoltaic module to the housing provides sufficient force to securely attach the photovoltaic module to the light fixture.

In other implementations, the photovoltaic construction may be coupled to an inner surface of the housing through a mold compound. The mold compound may include, by nonlimiting example, an epoxy, polyester, or other thermal polymer resin that can act as a substrate or adhesive between the photovoltaic module and the housing of the light fixture.

In other implementations where the photovoltaic module includes or is coupled to a metallic back plate, the method of coupling the photovoltaic construction to a metallic housing may include welding the metallic back plate to the housing. In such implementations, a spot weld or speed weld may be used to fix the photovoltaic construction to the housing.

In other implementations, the photovoltaic construction may be coupled to the interior surface of the housing through an adhesive. The adhesive may include, by nonlimiting example, in an epoxy, polyester, cyanoacrylate, natural rubber cements, synthetic rubber cements, ultraviolet activated adhesives, heat activated adhesives, adhesive tapes, or other adhesives or media containing adhesives that will successfully bond the photovoltaic construction to the housing.

In other implementations, one or more clips may be used to attach the photovoltaic construction to the housing. In still other implementations, other attachment mechanisms may be used to attach the photovoltaic module within the housing of the light fixture.

The various implementations, the method of forming the photovoltaic light fixture may include either adding the photovoltaic construction to an existing light fixture or forming the light fixture and also adding the photovoltaic construction to the light fixture. In implementations where the light fixture is formed in addition to adding the photovoltaic construction to the light fixture, the method may include forming a light fixture housing, coupling a bulb connector or bulb attachment mechanism within the housing, and providing wiring configured to power the bulb or light emitting device. In implementations including a ballast, the method may include attaching the ballast to the light fixture.

In other implementations, rather than forming the light fixture, the method of forming the photovoltaic light fixture may be used in a method of retrofitting an existing light fixture and converting it into a photovoltaic light fixture. In such implantations, the method of retrofitting may include removing one or more bulbs from a light fixture and removing the light fixture from the structure or device in which it is installed. Once the light fixture is removed, the methods of retrofitting a light fixture includes coupling a photovoltaic construction within the housing, as disclosed herein. The method of retrofitting a light fixture may also include reinstalling the light fixture within the structure or device and replacing the one or more bulbs removed from the light fixture.

Implementations of the methods of forming a photovoltaic light fixture disclosed herein all produce photovoltaic light fixtures that generate electricity from otherwise wasted photons that strike and/or are absorbed by the interior of a light fixture. Further, the implementations of light fixtures produced are safe inasmuch as the photovoltaic modules are within the housing and are not typically positioned in a location that is readily accessible by people or animals. Still further, the photovoltaic modules of the light fixtures produced are also housed and protected by the housing, thus further increasing the longevity of the photovoltaic modules within the light fixture.

In places where the description above refers to particular implementations of methods of forming a photovoltaic light fixture and implementing components, sub-components, methods and sub-methods, it should be readily apparent that a number of modifications may be made without departing from the spirit thereof and that these implementations, implementing components, sub-components, methods and sub-methods may be applied to other methods of forming a photovoltaic light fixture.

What is claimed is:

1. A method of forming a photovoltaic light fixture, the method comprising:
coupling a photovoltaic construction to an interior surface of a light fixture housing, the photovoltaic construction comprising:
a photovoltaic module comprising a plurality of photovoltaic cells; and
outgoing photovoltaic wiring directly coupled electrically and mechanically to the photovoltaic module; and
electrically coupling the outgoing photovoltaic wiring to one of a battery or a capacitor;
wherein the outgoing photovoltaic wiring comprises one of a universal serial bus (USB) cable or a power over ethernet (PoE) cable;
wherein the one of the USB cable or the PoE cable is configured to harvest power from the photovoltaic module.

2. The method of claim 1, further comprising forming one or more openings through the housing through which the outgoing photovoltaic wiring is configured to extend.

3. The method of claim 1, wherein the outgoing photovoltaic wiring comprises the USB cable.

4. The method of claim 3, wherein the USB cable harvests the power through only two of four conductors within the USB cable.

5. The method of claim 4, wherein the USB cable is configured to harvest between 1-71 watts through each conductor that harvests the power.

6. The method of claim 1, wherein the outgoing photovoltaic wiring comprises the PoE cable.

7. The method of claim 6, wherein the PoE cable harvests the power through only four of eight conductors within the PoE cable.

8. The method of claim 7, wherein the PoE cable is configured to harvest between 1-71 watts through each conductor that harvests the power.

9. The method of claim 1, wherein the photovoltaic module is configured to generate electricity when exposed to light having a wavelength between 380-750 nanometers.

10. A method of forming a photovoltaic light fixture, the method comprising:
coupling a photovoltaic construction to an interior surface of a light fixture housing through a plurality of magnets, the photovoltaic construction comprising:
a photovoltaic module comprising a plurality of photovoltaic cells, the photovoltaic module fixedly coupled to a backplate; and
outgoing photovoltaic wiring directly coupled electrically and mechanically to the photovoltaic module; and
electrically coupling the outgoing photovoltaic wiring to one of a battery or a capacitor;
wherein the outgoing photovoltaic wiring comprises one of a universal serial bus (USB) cable or a power over ethernet (PoE) cable;
wherein the one of the USB cable or the PoE cable is configured to harvest power from the photovoltaic module;
wherein the plurality of magnets are directly coupled to the backplate;
wherein the photovoltaic module is configured to be between the housing and a lightbulb housed by the housing; and
wherein the photovoltaic module is configured to generate electricity using visible light emitted from the lightbulb.

11. The method of claim 10, further comprising forming one or more openings through the housing through which the outgoing photovoltaic wiring is configured to extend.

12. The method of claim 10, wherein the outgoing photovoltaic wiring comprises the USB cable and wherein the USB cable is configured to harvest the power through only two of four conductors within the USB cable.

13. The method of claim 10, wherein the outgoing photovoltaic wiring comprises the PoE cable and wherein the PoE cable is configured to harvest the power through only four of eight conductors within the PoE cable.

14. The method of claim 10, wherein the one of the USB cable or PoE cable is configured to harvest between 1-71 watts through each conductor that harvests the power in the one of the USB cable or the PoE cable.

15. The method of claim 10, wherein the photovoltaic module is configured to generate electricity when exposed to light having a wavelength between 380-750 nanometers.

16. A method of retrofitting a light fixture, the method comprising:
removing a light fixture from a structure;
removing one or more bulbs from the light fixture;
coupling a photovoltaic construction to an interior surface of a light fixture housing, the photovoltaic construction comprising:
a photovoltaic module comprising a plurality of photovoltaic cells; and
outgoing photovoltaic wiring directly coupled electrically and mechanically to the photovoltaic module;
electrically coupling the outgoing photovoltaic wiring to one of a battery or a capacitor;
reinstalling the one or more bulbs into the light fixture; and
reinstalling the light fixture to the structure;
wherein the outgoing photovoltaic wiring comprises one of a universal serial bus (USB) cable or a power over ethernet (PoE) cable;
wherein the one of the USB cable or the PoE cable is configured to harvest power from the photovoltaic module; and
wherein the photovoltaic module is configured to generate electricity using visible light emitted from the one or more bulbs.

17. The method of claim 16, wherein the one or more lightbulbs are low voltage lightbulbs.

18. The method of claim 16, further comprising forming one or more openings through the housing through which the outgoing photovoltaic wiring is configured to extend.

19. The method of claim 16, wherein the outgoing photovoltaic wiring comprises the USB cable and wherein the USB cable is configured to harvest the power through only two of four conductors within the USB cable.

20. The method of claim 16, wherein the outgoing photovoltaic wiring comprises the PoE cable and wherein the PoE cable is configured to harvest the power through only four of eight conductors within the PoE cable.
